(19) United States
(12) Patent Application Publication
(10) Pub. No.: US 2024/0388486 A1
(43) Pub. Date: Nov. 21, 2024

(54) COMMUNICATION APPARATUS AND COMMUNICATION METHOD FOR PREAMBLE OF ALIGNED PPDUS

(71) Applicant: Panasonic Intellectual Property Corporation of America, Torrance, CA (US)

(72) Inventors: Yanyi DING, Singapore (SG); Yoshio URABE, Nara (JP); Rojan CHITRAKAR, Singapore (SG)

(21) Appl. No.: 18/693,861

(22) PCT Filed: Sep. 28, 2022
(86) PCT No.: PCT/SG2022/050699

§ 371 Date: Mar. 20, 2024

(30) Foreign Application Priority Data
Oct. 20, 2021 (SG) 10202111654V

(51) Int. Cl. H04L 27/26; H04L 5/00

(52) U.S. Cl. CPC H04L 27/26132; H04L 5/0048; H04L 5/0055; H04L 27/26526

(57) ABSTRACT

Communication devices and methods for preamble of aligned PPDUs are provided. One exemplary embodiment provides a first communication apparatus comprising: circuitry, which in operation, generates a first Physical Protocol Data Unit (PPDU) that is aligned with a second PPDU, wherein one or more fields of the first PPDU include one or more symbols having parameters that are different from that of one another; and a first transmitter, which in operation, transmits the first PPDU to a second communication apparatus.

### BACKGROUND

### 1. Technical Field

The present embodiments generally relate to communication apparatuses, and more particularly relate to methods and apparatuses for preamble of aligned Physical Protocol Data Units (PPDUs).

### 2. Description of the Related Art

In the standardization of next generation wireless local area network (WLAN), new radio access technology having backward compatibilities with IEEE 802.11a/b/g/n/ac/ax technologies has been discussed in the IEEE 802.11be Task Group and is named 802.11be Extremely High Throughput (EHT) WLAN.

In 11be EHT WLAN, in order to achieve good throughput gain over 11ax High Efficiency (HE) WLAN, some mechanisms have been proposed such as Aggregated PPDU (A-PPDU), Coordinated orthogonal frequency-division multiple access (C-OFDMA) and Coordinated Beamforming (C-BF).

However, there has been no discussion so far concerning the preamble design for such mechanisms.

There is thus a need for communication apparatuses and methods that can solve the above-mentioned issue. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for preamble of aligned Physical Protocol Data Units (PPDUs).

According to an aspect of the present disclosure, there is provided a first communication apparatus comprising: circuitry, which in operation, generates a first Physical Protocol Data Unit (PPDU) that is aligned with a second PPDU, wherein one or more fields of the first PPDU include one or more symbols having parameters that are different from that of one another; and a first transmitter, which in operation, transmits the first PPDU to a second communication apparatus.

According to another aspect of the present disclosure, there is provided a second communication apparatus, comprising: a receiver, which in operation, receives a first PPDU from a first communication apparatus, wherein the first PPDU is aligned with a second PPDU, wherein one or more fields of the first PPDU includes one or more symbols having parameters that are different from that of one another; and circuitry, which in operation, demodulates and decodes the symbols based on the parameters.

According to another aspect of the present disclosure, there is provided an access point (AP) comprising: a receiver, which in operation, receives a plurality of unaligned PPDUs; and circuitry, which in operation, demodulates and decodes the plurality of unaligned PPDUs utilizing a plurality of fast fourier transform (FFT) and inverse FFT (IFFT) processors.

According to another aspect of the present disclosure, there is provided a communication method comprising: generating a first PPDU that is aligned with a second PPDU, wherein one or more fields of the first PPDU include one or more symbols having parameters that are different from that of one another; and transmitting the first PPDU and the second PPDU.

It should be noted that general or specific embodiments may be implemented as a system, a method, an integrated circuit, a computer program, a storage medium, or any selective combination thereof. Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying figures where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 illustrates an illustration of an Aggregated PPDU (A-PPDU) according to an example.

FIG. 2 depicts an illustration of an example orthogonal frequency-division multiple access (OFDMA) transmission according to an example.

FIG. 3 depicts an illustration of two transmission scenarios for an access point (AP) with a single fast fourier transform (FFT)/inverse FFT (IFFT) processor according to an example.

FIG. 4 depicts an illustration of Guard Interval (GI) inclusion for OFDM symbol transmission according to an example.

FIG. 5 depicts an implementation of how different PPDUs are aligned according to an example.

FIG. 6 depicts an implementation of how different PPDUs are aligned according to another example.

FIGS. 7A and 7B depict illustrations of fields with variable lengths for High Efficiency (HE) multi-user (MU) PPDU and Extremely High Throughput (EHT) MU PPDU respectively according to an example.

FIGS. 8A and 8B depict illustrations of how HE/EHT-long training field (LTF) fields are generated in downlink (DL) PPDU for 4×HE/EHT-LTF and 1×/2×HE/EHT-LTF respectively according to an example.

FIG. 9 depicts an illustration of different PPDUs that are aligned according to an example.

FIG. 10 depicts an illustration of how fields in HE MU PPDU and EHT MU PPDU are aligned according to an embodiment 0.

FIGS. 11A and 11B depict illustrations of how EHT-signal (SIG) symbols are processed according to an embodiment 0.

FIG. 12 depicts an illustration of how fields in HE MU PPDU and EHT MU PPDU are aligned according to an embodiment 0.

FIG. 13 depicts an illustration of how fields in a HE MU PPDU and an EHT MU PPDU are aligned according to an embodiment 1.

FIG. 14 depicts an illustration of how fields in an EHT PPDU are aligned with other PPDUs according to an embodiment 1.

FIG. 15 depicts an illustration of how EHT-LTF symbols in an EHT-LTF field are generated according to an embodiment 1.

FIG. 16 depicts an illustration of how alignment-required EHT-LTF symbols of 1×/2×EHT-LTF type are generated according to an embodiment 1.

FIG. 17 depicts an illustration of how EHT-LTF symbols in an EHT-LTF field for single user (SU) transmission are received according to an embodiment 1.

FIG. 18 depicts an example illustration of how fields of an EHT PPDU are aligned with fields of other PPDU(s) in accordance with an embodiment 2.

FIG. 19 depicts another example illustration of how fields of an EHT PPDU are aligned with fields of other PPDU(s) in accordance with an embodiment 2.

FIG. 20 depicts an example illustration of how Extra EHT-STF symbols are used for aligning fields of an EHT PPDU with fields of other PPDU(s) in accordance with an embodiment 2.

FIG. 21 depicts an example illustration of how Extra EHT-LTF symbols are used for aligning fields of an EHT PPDU with fields of other PPDU(s) in accordance with an embodiment 2.

FIG. 22 depicts an illustration of how EHT-LTF symbols of 1×EHT-LTF type are generated in accordance with an embodiment 2.

FIG. 23 depicts an illustration of how EHT-LTF symbols of 2×EHT-LTF or 4×EHT-LTF type are generated in accordance with an embodiment 2.

FIG. 24 depicts an illustration of how EHT-LTF symbols in an EHT-LTF field for SU transmission are received in accordance with an embodiment 2.

FIG. 25 depicts an illustration of an unaligned PPDU transmission in accordance with an embodiment 3.

FIG. 26 depicts an illustration of OFDM transmission with multiple IFFT processors in accordance with an embodiment 3.

FIG. 27 depicts an illustration of how fields in an EHT PPDU are aligned with other PPDUs according to a combination of embodiments 1 and 2.

FIG. 28 depicts an illustration of how EHT-LTF symbols of different EHT-LTF types are generated in accordance with a combination of embodiments 1 and 2.

FIG. 29 shows a flow diagram illustrating a communication method for preamble of aligned PPDUs according to various embodiments.

FIG. 30 shows a schematic, partially sectioned view of a communication apparatus that can be implemented for preamble of aligned PPDUs in accordance with various embodiments.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the embodiments or the application and uses of the embodiments. Furthermore, there is no intention to be bound by any theory presented in the preceding Background or this Detailed Description. Furthermore, other desirable features and characteristics will become apparent from the subsequent detailed description and the appended claims, taken in conjunction with the accompanying drawings and this background of the disclosure.

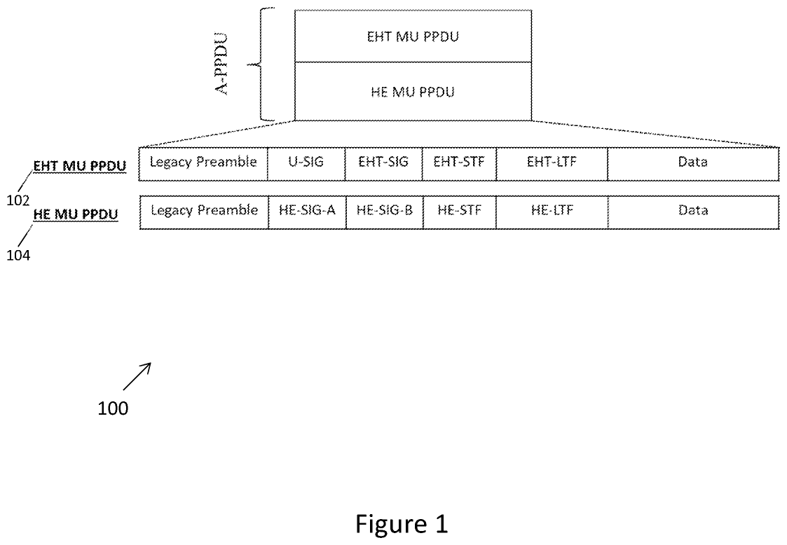

In several scenarios of 11be (e.g., as discussed in 11-20-0831-02-00be—trigger frame for frequency-domain A-PPDU support, in regards to A-PPDU, C-OFDMA, and C-BF), orthogonality between different PPDUs may be required. Different amendments of aligned PPDUs may include, for example, HE and EHT. PPDUs should be orthogonal in frequency domain symbol-by-symbol. For example, referring to A-PPDU 100 of FIG. 1, an EHT MU PPDU 102 and a HE MU PPDU 104 of A-PPDU 100 are both aligned symbol-by-symbol.

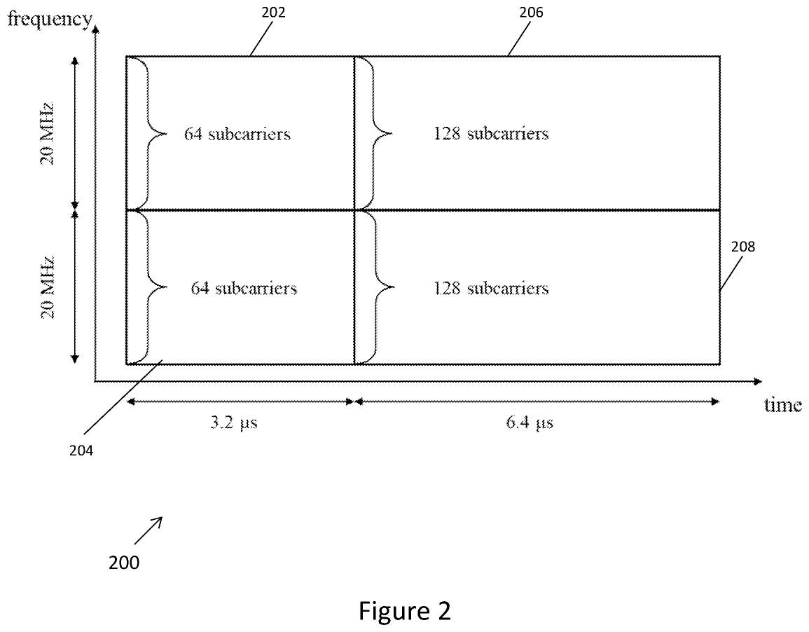

FIG. 2 depicts an illustration 200 of an example OFDMA transmission according to an example. Time duration of each OFDM symbol data part is determined by discrete fourier transform (DFT) periods (i.e., the number of used subcarriers and bandwidth). For example, OFDM data parts 202 and 204 each comprises 64 subcarriers and have a time duration of 3.2 μs each, while OFDM data parts 206 and 208 each comprise 128 subcarriers and have a time duration of 6.4 μs each.

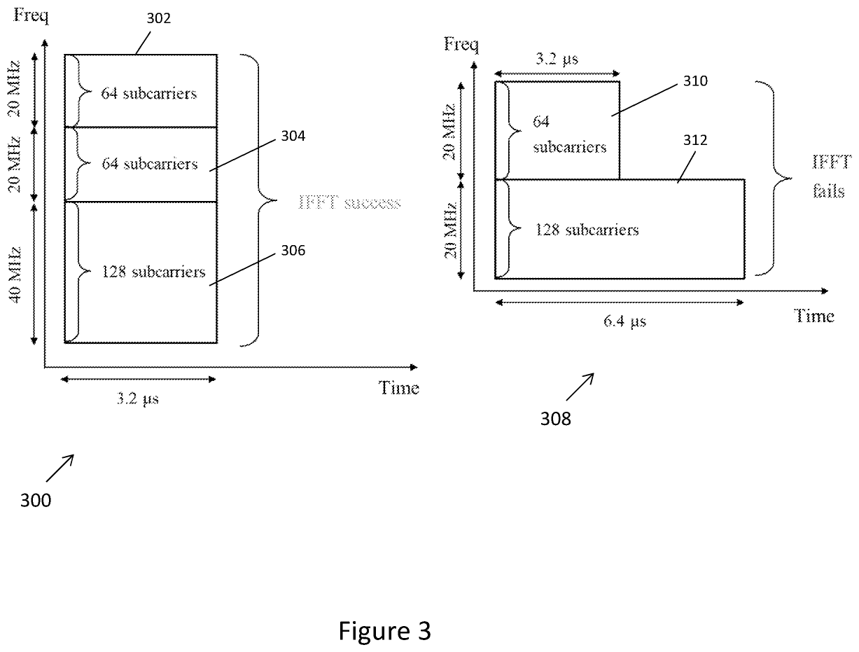

When an AP uses a single IFFT/FFT processor to generate multiple PPDUs, if OFDM symbol data parts with same DFT periods are not aligned in time domain, the IFFT window cannot line-up and will cause non-orthogonality. Referring to FIG. 3, illustration 300 shows an example of a successful IFFT generation of multiple PPDUs in which all OFDM symbol data parts 302, 304 and 306 are each of DFT period 3.2 μs and are thus aligned with one another. On the other hand, illustration 308 shows an example of an unsuccessful IFFT generation of two PPDUs, in which OFDM symbol data part 310 is of DFT period 3.2 μs and data part 312 is of DFT period 6.4 μs, and are therefore not aligned with each other. DFT periods that are supported in 802.11ax/be include 3.2, 6.4, and 12.8 μs.

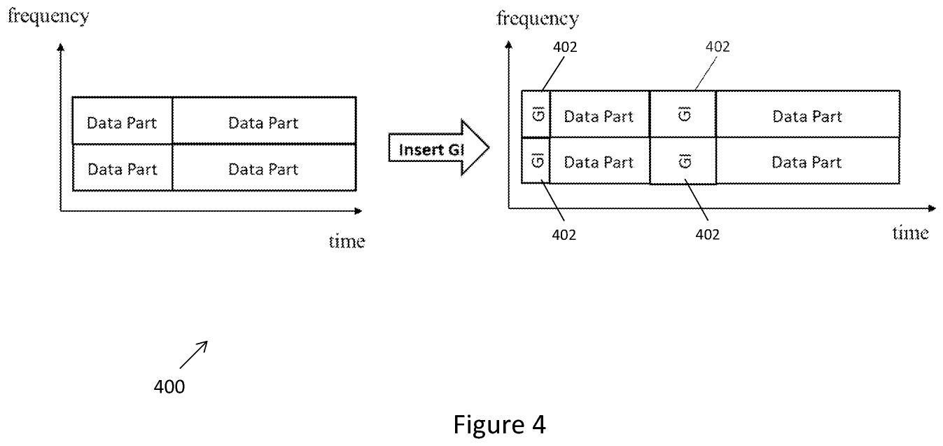

In 802.11 ax/be, each OFDM symbol in time duration includes two parts, namely Guard Interval (GI) consisting of durations 0.8 μs, 1.6 μs or 3.2 μs, and data part consisting of durations 3.2 μs, 6.4 μs, 12.8 μs for HE/EHT-LTF symbols, 3.2 μs for pre-HE/EHT modulated symbols, and 12.8 μs for data symbols. Referring to illustration 400 of FIG. 4, GI 402 is inserted on transmission after IFFT (i.e., in time domain) and removed on reception before FFT. The GI of symbols aligned in time domain across different frequencies shall be of a same duration.

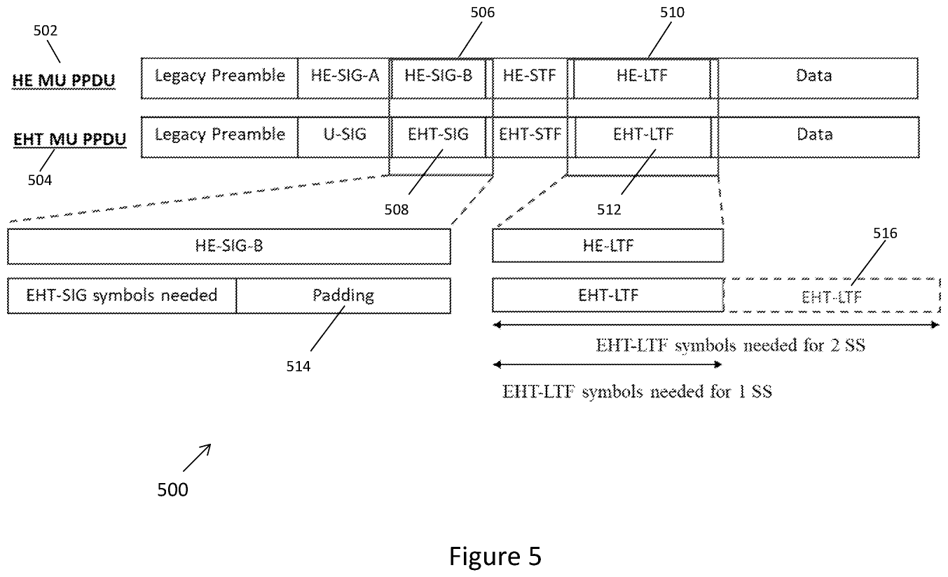

The easiest way to ensure the orthogonality and alignment between different PPDUs is to keep each field aligned, because symbols within a same field are of same DFT period. Referring to illustration 500 of FIG. 5, since only durations of HE-SIG-B field 506 and HE-LTF field 510 of HE MU PPDU 502, as well as EHT-SIG field 508 and EHT-LTF field 512 of EHT MU PPDU 504 are variable, the key point here is to keep HE-SIG-B field 506 and EHT-SIG field 508 aligned with each other, as well as keep HE-LTF field 510 and EHT-LTF field 512 aligned with each other. One option for achieving the alignment is by adding MAC padding bits 514, and/or adjusting the transmit parameters e.g. using less spatial streams (SS) to transmit. For example, by using only one SS instead of two SS for transmission, only one instead of two EHT-LTF symbol is required, and thus EHT-LTF symbol 516 can be omitted such that HE-LTF field 510 and EHT-LTF field 512 can be aligned with each other.

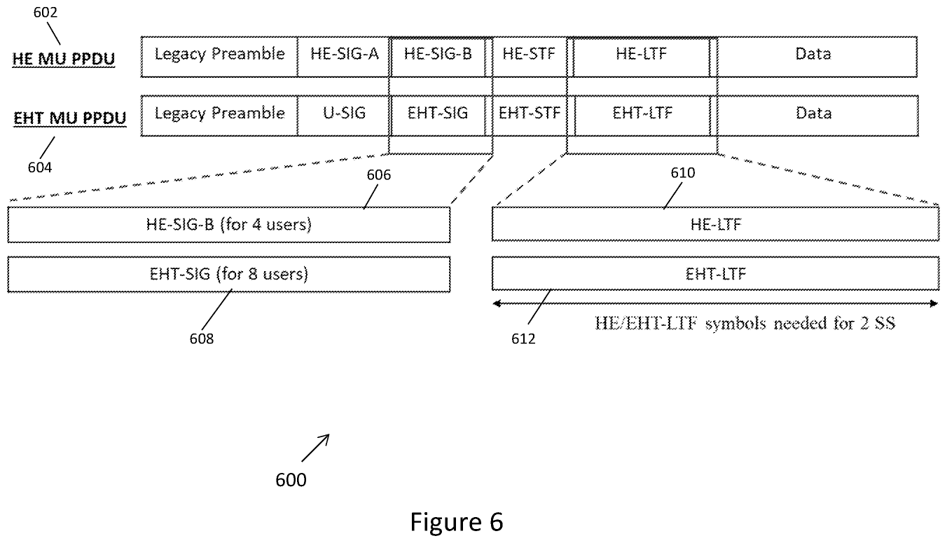

In another option, alignment can be achieved by appropriate scheduling. For example, referring to illustration 600 of FIG. 6, more users may be set to be target receivers of EHT MU PPDU 604 so that EHT-SIG field 608 can be of same length as HE-SIG-B field 606 of HE MU PPDU 602. Further, more Spatial Streams may be utilized in HE MU PPDU 602 (e.g. 2 SS instead of 1 SS) so that HE-LTF field 610 has the same length as that of EHT-LTF field 612 such that both fields are aligned with each other.

In 11be, there are some changes from 11ax in preamble as shown in Table 1 below:

TABLE 1

| | 11ax | 11be |
|---|---|---|
| Max. number of SS | 8 | 16 |
| Number of LTF | Number of HE-LTFs is | The number of EHT-LTFs |
| symbols | determined by the total | may be larger than the initial |
| | number of spatial | number of EHT-LTFs |
| | streams | determined by the total |
| | (<=8) | number of spatial streams |
| | | (could be larger than 16) |
| HE-SIG-B/EHT- | HE-SIG-B carries | EHT-SIG may carry |
| SIG | duplicated content in | different content in each 80 |
| | each 40 MHz | MHz |

Thus, it is very possible that the EHT-SIG field may be shorter than the HE-SIG-B field, and EHT-LTF field may be longer than the HE-LTF field (i.e., more EHT-LTF symbols are needed than HE-LTF symbols). In this case, the alignment may lead to EHT-SIG field using a longer duration than it really needs, the number of SS that can be used in EHT MU PPDU is limited, and the HE-LTF field cannot align with EHT-LTF field by adding extra LTF symbols when the number of LTF symbols is larger than 8.

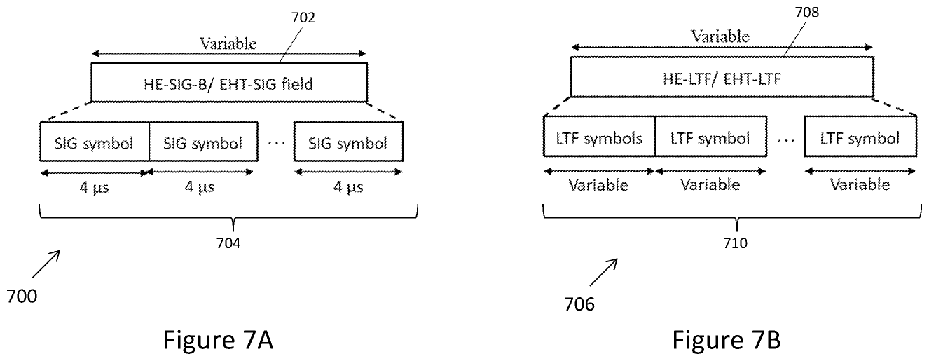

There are two fields of variable length in HE MU PPDU and EHT MU PPDU respectively. Referring to illustration 700 of FIG. 7A, HE-SIG-B/EHT-SIG field 702 includes variable numbers of HE-SIG-B/EHT-SIG symbols 704, each of 4 μs in length. Referring to illustration 706 of FIG. 7B, HE-LTF/EHT-LTF field 708 includes variable numbers of HE/EHT-LTF symbols 710, each having variable duration. In 11ax/11be, the duration of a single LTF symbol is determined by the type of HE/EHT-LTF and the GI, as shown in Table 2 below:

TABLE 2

| HE-LTF/EHT-LTF + GI | Duration of HE/EHT-LTF symbol |
|---|---|
| 1x HE/EHT-LTF + 0.8 μs GI | 3.2 + 0.8 = 4 μs |
| 1x HE/EHT-LTF + 1.6 μs GI | 3.2 + 1.6 = 4.8 μs |
| 2x HE/EHT-LTF + 0.8 μs GI | 6.4 + 0.8 = 7.2 μs |
| 2x HE/EHT-LTF + 1.6 μs GI | 6.4 + 1.6 = 8 μs |
| 4x HE/EHT-LTF + 0.8 μs GI | 12.8 + 0.8 = 13.6 μs |
| 4x HE/EHT-LTF + 3.2 μs GI | 12.8 + 3.2 = 16 μs |

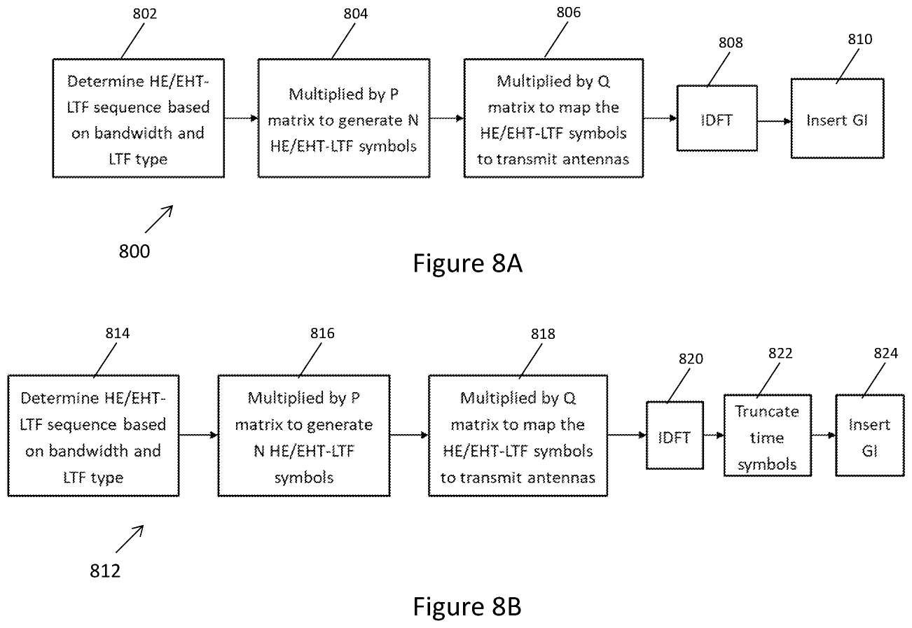

In 11ax/11be, the generation of HE/EHT-LTF field in a DL PPDU depends on the type of HE/EHT-LTF field. FIG. 8A depicts an illustration 800 of how HE/EHT-LTF fields are generated in DL PPDU for 4×HE/EHT-LTF type. In step 802, HE/EHT-LTF sequence is determined based on bandwidth and LTF type. In step 804, the sequence is multiplied by a P matrix to generate N HE/EHT-LTF symbols. In step 806, the result of step 804 is multiplied by a Q matrix to map the HE/EHT-LTF symbols to transmit antennas. In step 808, IDFT is performed. In step 810, GI is inserted. Further, FIG. 8B depicts an illustration 812 of how HE/EHT-LTF fields are generated in DL PPDU for 1×/2×HE/EHT-LTF type. In step 814, HE/EHT-LTF sequence is determined based on bandwidth and LTF type. In step 816, the sequence is multiplied by a P matrix to generate N HE/EHT-LTF symbols. In step 818, the result of step 816 is multiplied by a Q matrix to map the HE/EHT-LTF symbols to transmit antennas. In step 820, IDFT is performed. In step 822, the time symbols from step 818 are truncated. In step 824, GI is inserted.

There are two possible ways for transmitting multiple PPDUs simultaneously by a single AP (e.g. via A-PPDU) or more than one AP (e.g. via C-OFDMA, C-BF), namely by transmitting aligned PPDUs or unaligned PPDUs. To transmit aligned PPDUs, multiple PPDUs are aligned symbol by symbol while the fields do not have to be aligned across the PPDUs. In this case, symbols included in a same field may be of different parameters (e.g., length, DFT periods, information carried, etc.). Example scenarios may be when C-OFDMA or C-BF scheme is used, or when the A-PPDU signal across a whole bandwidth is correlated (i.e., the AP uses a single IFFT processor to convert the A-PPDU to a time-domain signal). To transmit unaligned PPDUs, an example scenario may be when the A-PPDU signal is not correlated in different frequency portions (i.e., the AP uses different IFFT processors for PPDUs in different frequency portions to convert the A-PPDU to time-domain signal, similar to 80+80 MHz transmission).

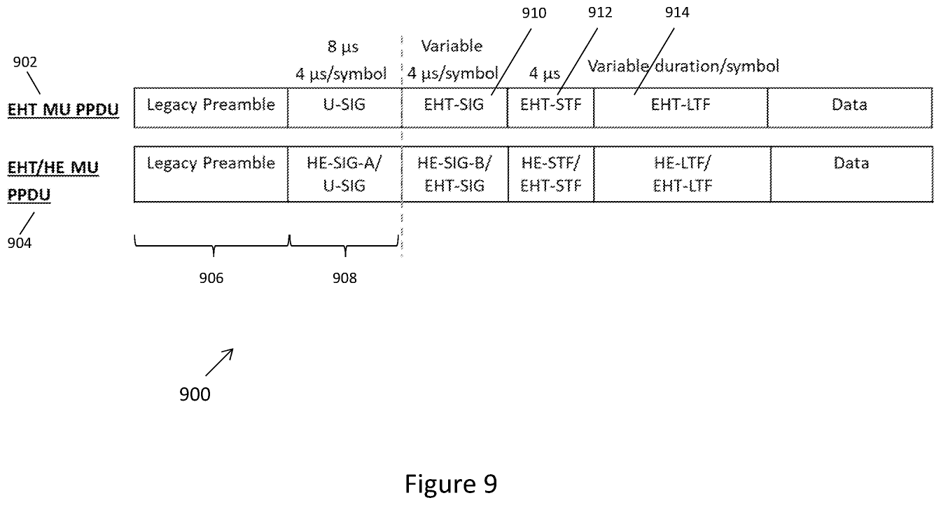

Referring to illustration 900 of FIG. 9, to transmit aligned PPDUs (e.g. EHT MU PPDU 902 and EHT/HE MU PPDU 904 are aligned), PPDUs are aligned symbol by symbol such that each symbol instead of field is aligned. Legacy preamble 906 and U-SIG/HE-SIG-A field 908 will be aligned naturally as the legacy part is fixed, and U-SIG field and HE-SIG-A field are each fixed to 8 μs long with two symbols of 4 μs. Design for alignment is related to fields after U-SIG field. For example, EHT-SIG field 910 is of variable duration with variable number of 4 μs EHT-SIG symbols, EHT-LTF field 914 is of variable duration with variable number of EHT-LTF symbols of variable duration, and EHT-STF field 912 is of 4 μs with a single 4 μs EHT-STF symbol.

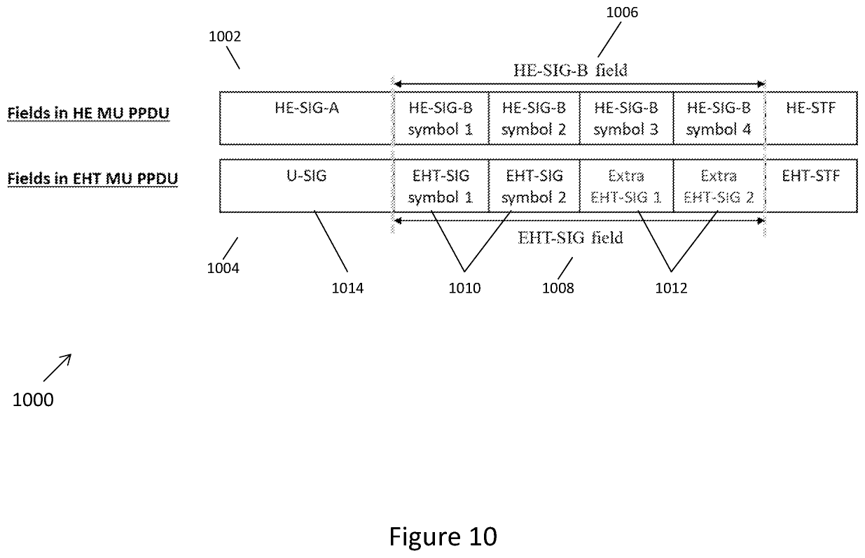

According to an embodiment 0, in an EHT PPDU required to be aligned with other PPDU(s), the alignment status of fields may be such that the EHT-SIG field is aligned with the HE-SIG-B/EHT-SIG field of other PPDU(s). FIG. 10 depicts an illustration 1000 of how fields in HE MU PPDU 1002 and EHT MU PPDU 1004 are aligned according to embodiment 0. In EHT-SIG field 1008, Extra EHT-SIG symbols 1012 added for alignment with HE-SIG-B field 1006 may be duplicated EHT-SIG symbols or extra EHT-SIG symbols carrying other information (e.g., information for Multi-AP transmission). The number of original EHT-SIG symbols 1010 and Extra EHT-SIG symbols 1012 shall be indicated in U-SIG field 1014. With duplicated EHT-SIG symbols, the SNR of EHT-SIG field can be advantageously improved; with EHT-SIG symbols carrying other information, more information can advantageously be carried.

Table 3 below shows example U-SIG field formats:

TABLE 3

| U-SIG part | Bit | Field |
|---|---|---|
| U-SIG-1 | B0-B2 | PHY Version Identifier |
| | B3-B5 | BW |
| | B6 | UL/DL |
| | B7-B12 | BSS Color |
| | B13-B19 | TXOP |
| | B20-B24 | Number of Extra EHT-SIG Symbols |
| | B25 | Validate |
| U-SIG-2 | B0-B1 | PPDU Type and Compression Mode |
| | B2 | Validate |
| | B3-B7 | Punctured Channel Information |
| | B8 | Validate |
| | B9-B10 | EHT-SIG MCS |
| | B11-B15 | Number Of EHT-SIG Symbols |
| | B16-B19 | CRC |
| | B20-B25 | Tail |

For bits B20-B24 of U-SIG-1 which is considered ‘Disregard Bits’ in 11be R1, the number of Extra EHT-SIG symbols may be indicated. For bits B11-B15, the number of EHT-SIG symbols may be indicated. Accordingly, such an arrangement advantageously ensures that backward compatibility to 11be R1 can be achieved.

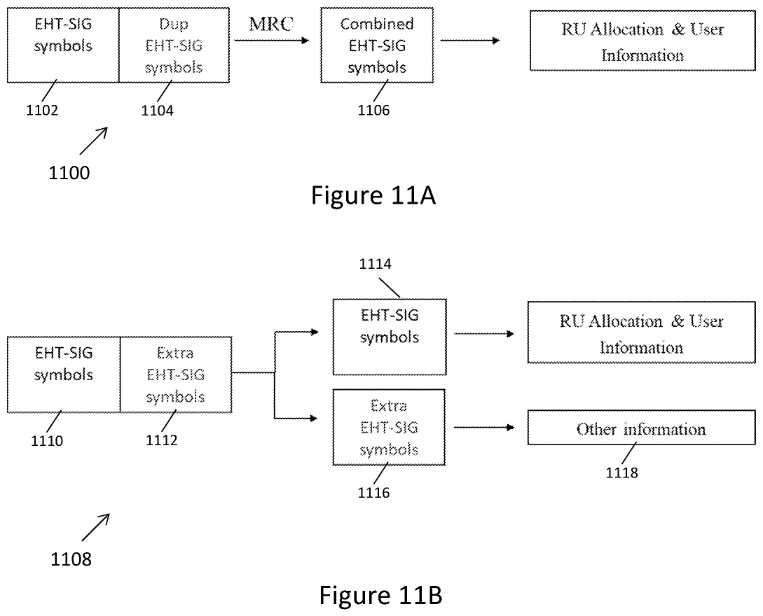

If the indicated ‘Number of Extra EHT-SIG Symbols’ is larger than 0, reception of EHT-SIG symbols in the EHT-SIG field according to embodiment 0 is as shown in FIGS. 11A and 11B. In one option, referring to illustration 1100 of FIG. 11A, when Extra EHT-SIG symbols 1104 are duplicated EHT-SIG symbols, EHT-SIG symbols 1102 and Extra EHT-SIG symbols 1104 are combined by maximum ratio combining (MRC) to form combined EHT-SIG symbols 1106, so as to improve SNR in EHT-SIG field. In another option, referring to illustration 1108 of FIG. 11B, when Extra EHT-SIG symbols 1112 carries other information, EHT-SIG symbols 1110 are demodulated and decoded (e.g. in process 1114) in a same way as defined in 11be R1. The Extra EHT-SIG symbols 1112 are demodulated and decoded separately (e.g. in process 1116) from the EHT-SIG symbols 1110 to obtain the carried information 1118.

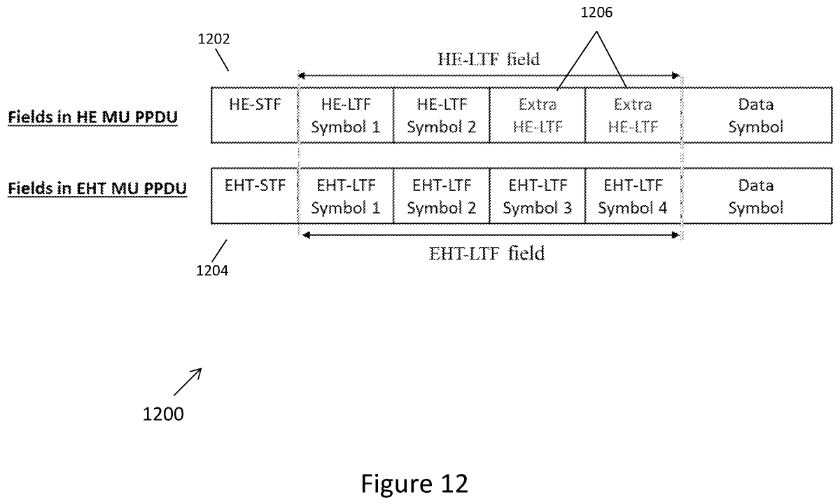

Further according to embodiment 0, in an EHT PPDU required to be aligned with other PPDU(s), the alignment status of fields may be such that the EHT-LTF field is aligned with the HE-LTF field of other PPDU(s). FIG. 12 depicts an illustration 1200 of how fields in HE MU PPDU 1202 and EHT MU PPDU 1204 are aligned according to embodiment 0. In a HE PPDU that is contained in an A-PPDU, extra HE-LTF symbols (e.g. Extra HE-LTF symbols 1206) can be added for alignment. The maximal total number of HE-LTF symbols is 8. Only the total quantity or number of HE-LTF symbols needs to be indicated, while the quantity or number of extra HE-LTF symbols need not to be indicated. The extra HE-LTF symbols 1206 can only be present when the HE PPDU is transmitted by an EHT device. The extra HE-LTF symbols 1206 will not bring any benefit or impact to receiver STAs and are present just for alignment purposes.

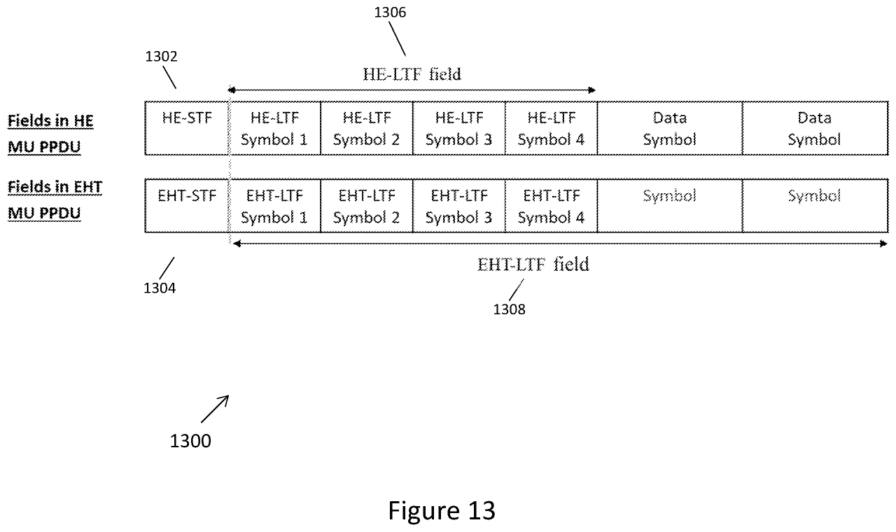

FIG. 13 depicts an illustration 1300 of how fields in a HE MU PPDU 1302 and an EHT MU PPDU 1304 are aligned according to an embodiment 1. For example, in an EHT PPDU required to be aligned with other PPDU(s) according to embodiment 1, the alignment status of fields may be such that the start of EHT-LTF field (e.g. EHT-LTF field 1308) is aligned with the start of HE/EHT-LTF field (e.g. HE-LTF field 1306) of other PPDU(s). The end of HE/EHT-LTF fields across multiple PPDUs need not be aligned.

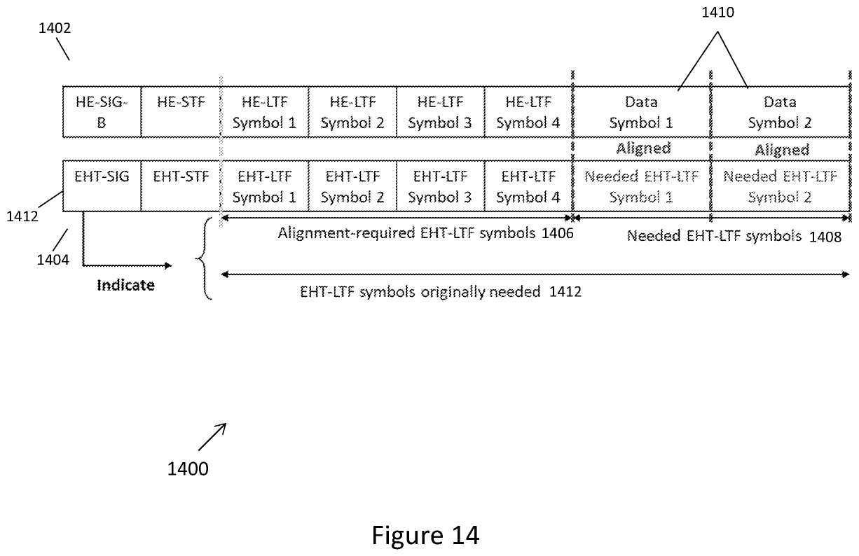

FIG. 14 depicts an illustration 1400 of how fields in an EHT PPDU (e.g. EHT PPDU 1404) are aligned with other PPDUs (e.g. HE PPDU 1402) according to an embodiment 1. Generation of EHT-LTF field in an EHT PPDU required to be aligned with other PPDUs is as follows: if the number of EHT-LTF symbols required by alignment (e.g. Alignment-required EHT-LTF symbols 1406) is equal to or larger than the amount originally needed by the EHT PPDU 1404, generation procedure is same as in 11be R1. If the number of Alignment-required EHT-LTF symbols 1406 is smaller than the amount originally needed, Needed EHT-LTF symbols 1408 are concatenated and aligned with Data symbol(s) of other PPDU (e.g. Data symbols 1410 of HE PPDU 1402) after the Alignment-required EHT-LTF symbols 1406 until the number of EHT-LTF symbols originally needed (e.g. EHT-LTF symbols originally needed 1412) is reached. Further, the number of Alignment-required EHT-LTF symbols 1406 and number of Needed EHT-LTF symbols 1408 shall be indicated in EHT-SIG field 1412.

Common field of EHT-SIG field format for OFDMA transmission and for non-OFDMA transmission may be as shown in below Tables 4 and 5 respectively:

TABLE 4

| Bit | Field |
|---|---|
| B0-B3 | Spatial Reuse |
| B4-B5 | GI + LTF Size |
| B6-B8 | Number of EHT-LTF Symbols |
| B9 | LDPC Extra Symbol Segment |
| B10-B11 | Pre-FEC Padding Factor |
| B12 | PE Disambiguity |
| B13-B16 | Number of Needed EHT-LTF |
| | symbols |
| B17-B16 + 9N | RU Allocation-1 |
| B17 + 9N-B20 + 9N | CRC |
| B21 + 9N-B26 + 9N | Tail |

TABLE 5

| Bit | Field |
|---|---|
| B0-B3 | Spatial Reuse |
| B4-B5 | GI + LTF Size |
| B6-B8 | Number of EHT-LTF Symbols |
| B9 | LDPC Extra Symbol Segment |
| B10-B11 | Pre-FEC Padding Factor |
| B12 | PE Disambiguity |
| B13-B16 | Number of Needed EHT-LTF |
| | symbols |
| B17-B19 | Number of Non-OFDMA Users |
| B20-B23 | CRC |
| B24-B29 | Tail |

In both Tables 4 and 5 above, bits B13-B16 is considered as ‘Disregard Bits’ in 11be R1 and used herein to indicate Number of Needed EHT-LTF symbols.

Table 6 below shows the three different durations of HE/EHT data symbol:

TABLE 6

| Guard interval (GI) duration | Duration of HE/EHT |
|---|---|
| for the Data field | Data symbol |
| 0.8 μs | 12.8 + 0.8 = 13.6 μs |
| 1.6 μs | 12.8 + 1.6 = 14.4 μs |
| 3.2 μs | 12.8 + 3.2 = 16 μs |

In order to align the Needed EHT-LTF symbols with Data symbols (both GI and OFDMA symbol), only two types of EHT-LTF symbol may be used, namely the ‘4×EHT-LTF+0.8 μs GI’ type and the ‘4×EHT-LTF+3.2 μs GI’ type (also shown in the two rows for GI durations of 0.8 μs and 3.2 μs in Table 6 above, as well as the last two rows of Table 7 below). When the GI is 1.6 μs, the Needed EHT-LTF symbol cannot be aligned with data symbol.

TABLE 7

| HE-LTF/EHT-LTF + GI | Duration of HE/EHT-LTF symbol |
|---|---|
| 1x HE/EHT-LTF + 0.8 μs GI | 3.2 + 0.8 = 4 μs |
| 1x HE/EHT-LTF + 1.6 μs GI | 3.2 + 1.6 = 4.8 μs |
| 2x HE/EHT-LTF + 0.8 μs GI | 6.4 + 0.8 = 7.2 μs |
| 2x HE/EHT-LTF + 1.6 μs GI | 6.4 + 1.6 = 8 μs |
| 4x HE/EHT-LTF + 0.8 μs GI | 12.8 + 0.8 = 13.6 μs |
| 4x HE/EHT-LTF + 3.2 μs GI | 12.8 + 3.2 = 16 μs |

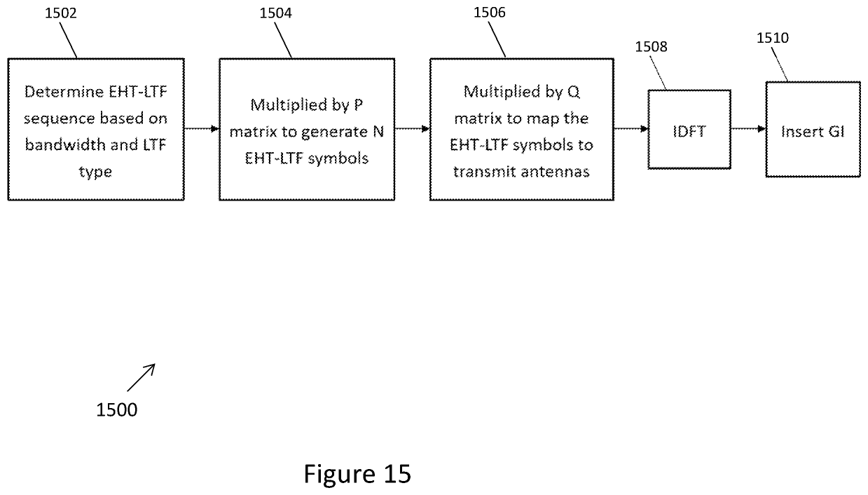

FIG. 15 depicts an illustration 1500 of how EHT-LTF symbols in an EHT-LTF field are generated according to embodiment 1 if the Alignment-required EHT-LTF symbols are of 4×EHT-LTF type. In step 1502, EHT-LTF sequence is determined based on bandwidth and LTF type. In step 1504, the sequence is multiplied by a P matrix to generate N EHT-LTF symbols. In step 1506, the result of step 1504 is multiplied by a Q matrix to map the EHT-LTF symbols to transmit antennas. In step 1508, IDFT is performed. In step 1510, GI is inserted. Thus, the Needed EHT-LTF symbols are generated together with the Alignment-required EHT-LTF symbols in the same way as defined in 11be R1.

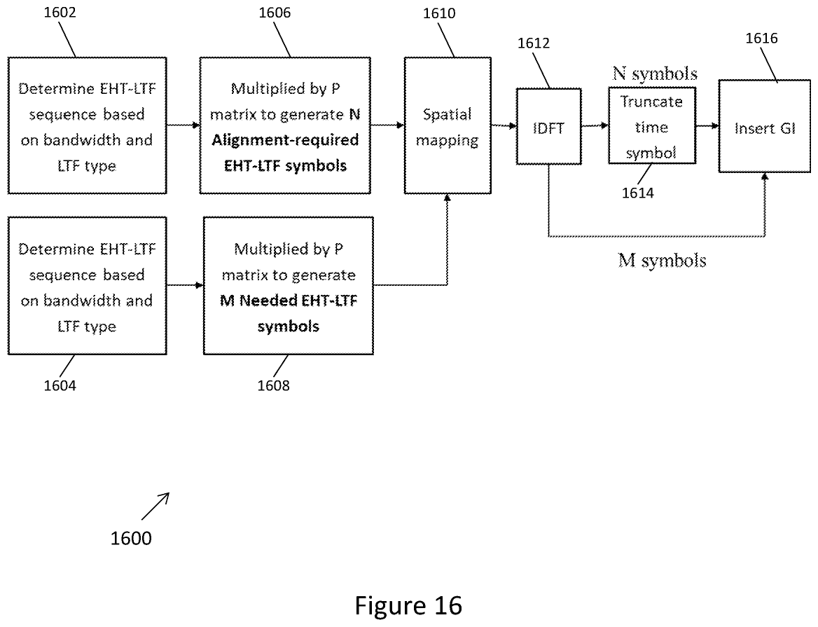

FIG. 16 depicts an illustration 1600 of how EHT-LTF symbols in an EHT-LTF field are generated according to embodiment 1 if the Alignment-required EHT-LTF symbols are of 1×/2×EHT-LTF type. In step 1602, EHT-LTF sequence for Alignment-required EHT-LTF symbols is determined based on bandwidth and LTF type. In step 1606, the sequence is multiplied by a P matrix to generate N Alignment-required EHT-LTF symbols. In step 1604, EHT-LTF sequence for Needed EHT-LTF symbols is determined based on bandwidth and LTF type. In step 1608, the sequence is multiplied by a P matrix to generate M Needed EHT-LTF symbols. In step 1610, spatial mapping is performed on the results of steps 1604 and 1608. In step 1612, IDFT is performed. In step 1614, only the N symbols are truncated. In step 1616, GI is inserted into both the N and M symbols.

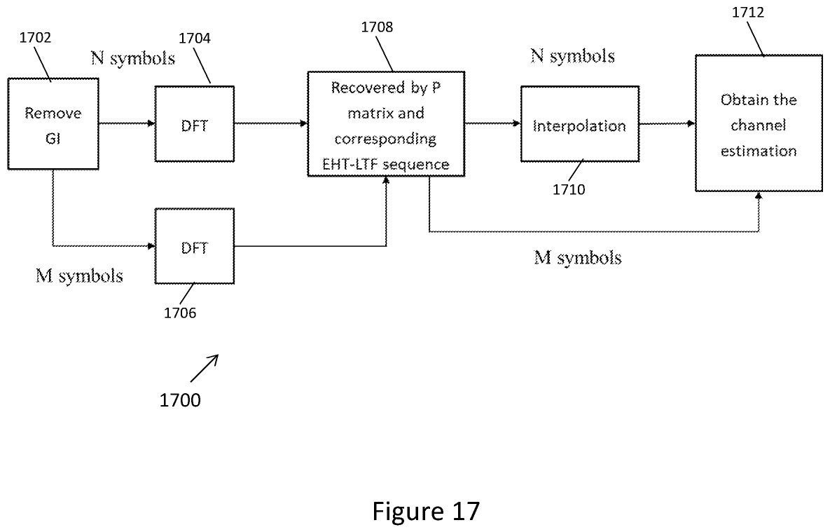

According to embodiment 1, during reception of EHT-LTF symbols in the EHT-LTF field for SU transmission, if the EHT-LTF type indicated in EHT-SIG field is ‘4×EHT-LTF’, the EHT-LTF field is demodulated and decoded as defined in 11be R1. On the other hand, if the EHT-LTF type indicated in EHT-SIG field is ‘1×EHT-LTF’ or ‘2×EHT-LTF’, a first option is to demodulate and decode the Alignment-required EHT-LTF symbols and Needed EHT-LTF separately, and a second option is to demodulate the Alignment-required EHT-LTF symbols and Needed EHT-LTF separately but decode them together after the Alignment-required EHT-LTF symbols are interpolated. FIG. 17 depicts an illustration 1700 of how EHT-LTF symbols in an EHT-LTF field for SU transmission are received based on the second option according to embodiment 1. In step 1702, GI is removed from both the N symbols (e.g. N symbols of the Alignment-required EHT-LTF symbols) and the M symbols (e.g. M symbols of the Needed EHT-LTF symbols). In steps 1704 and 1706, DFT is performed on the N symbols and the M symbols respectively. In step 1708, the N symbols and M symbols are recovered by P matrix and corresponding EHT-LTF sequence. In step 1710, the N symbols are interpolated. In step 1712, channel estimation information is obtained from the M symbols and interpolated N symbols.

According to embodiment 1, by appropriate assignment of EHT-LTF symbols to more than one users, the reception of EHT-LTF symbols in the EHT-LTF field for MU transmission can be configured to be the same as defined in 11be R1. EHT-LTF symbols assigned to a single user shall be of a same LTF type. In this case, the reception of EHT-LTF symbols in the EHT-LTF field for MU transmission is such that a receiver STA only demodulates the assigned EHT-LTF symbols and obtains channel information for the assigned Spatial Streams, and the reception procedure is the same as defined in 11be R1.

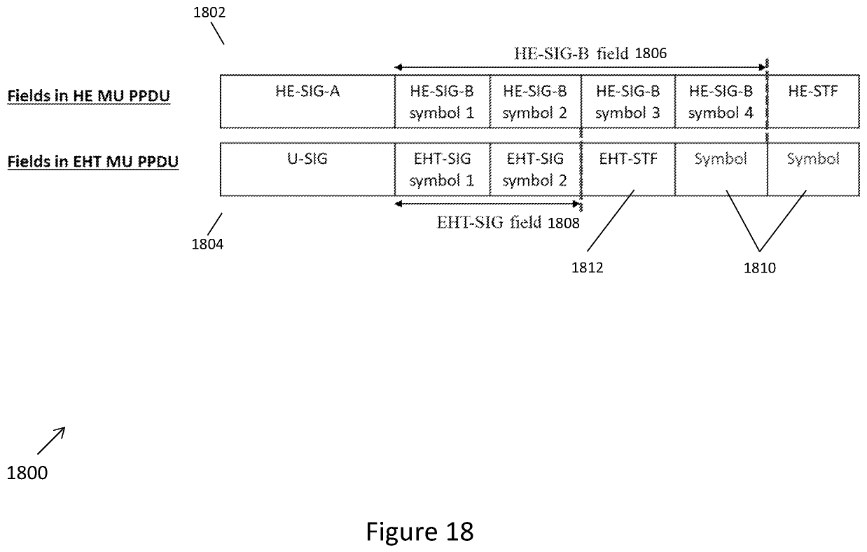

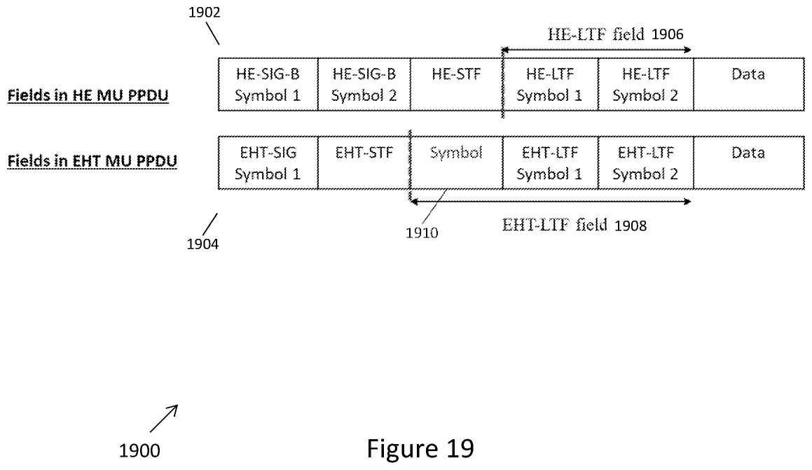

FIGS. 18 and 19 depict example illustration of how fields of an EHT PPDU are aligned with fields of other PPDU(s) in accordance with an embodiment 2. According to embodiment 2, in an EHT PPDU required to be aligned with other PPDU(s), the alignment status of fields may be such that the EHT-SIG field (e.g. EHT-SIG field 1808 of EHT MU PPDU 1804) needs not to be aligned with HE-SIG-B/EHT-SIG field of other PPDU(s) (e.g. symbols 1810 may be added after EHT-STF field 1812 as there is no need to align EHT-SIG field 1808 of EHT MU PPDU 1804 with HE-SIG-B field 1806 of HE MU PPDU 1802). Further, the start of EHT-LTF field (e.g. EHT-LTF field 1908 of EHT MU PPDU 1904) needs not to be aligned with the start of HE/EHT-LTF field of other PPDU(s) (e.g. HE-LTF field 1906 of HE MU PPDU 1902). Even further, symbol(s) (e.g. symbol 1910) between EHT-STF and original EHT-LTF field can be any symbol(s) that aligned with corresponding symbol(s) of other PPDU(s).

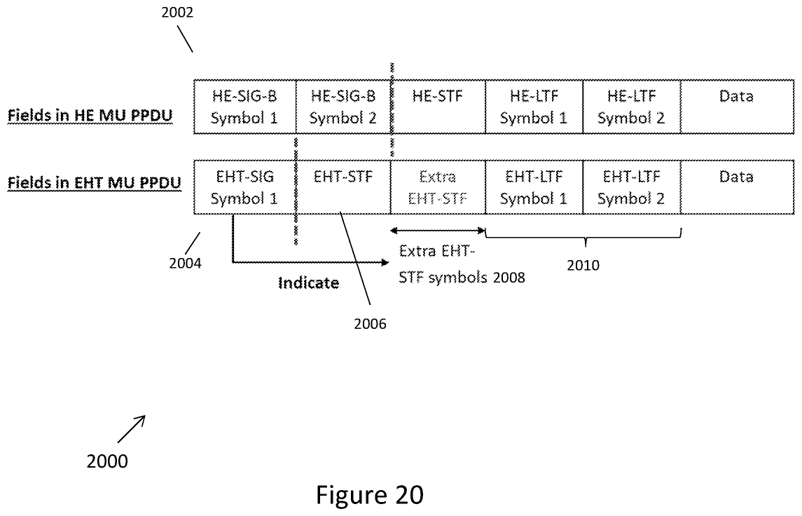

FIG. 20 depicts an example illustration 2000 of how Extra EHT-STF symbols 2008 are used for aligning fields of an EHT PPDU (e.g. EHT MU PPDU 2004) with fields of other PPDU(s) (e.g. HE MU PPDU 2002) in accordance with embodiment 2. For example, symbol(s) between EHT-STF field and original EHT-LTF field may be Extra EHT-STF symbol(s) (e.g. Extra EHT-STF symbol 2008 between EHT-STF field 2006 and original EHT-LTF field 2010 of EHT MU PPDU 2004). In this case, the generation of EHT-STF field in an EHT PPDU required to be aligned with other PPDU(s) may be such that the generation procedure is the same as that defined in 11be R1 if the number of Extra EHT-STF symbol is 0, and the Extra EHT-STF symbol(s) may be duplicated EHT-STF symbol(s) if the number of Extra EHT-STF symbol(s) is larger than 0. With duplicated EHT-STF symbol(s), the SNR of EHT-STF field can advantageously be improved.

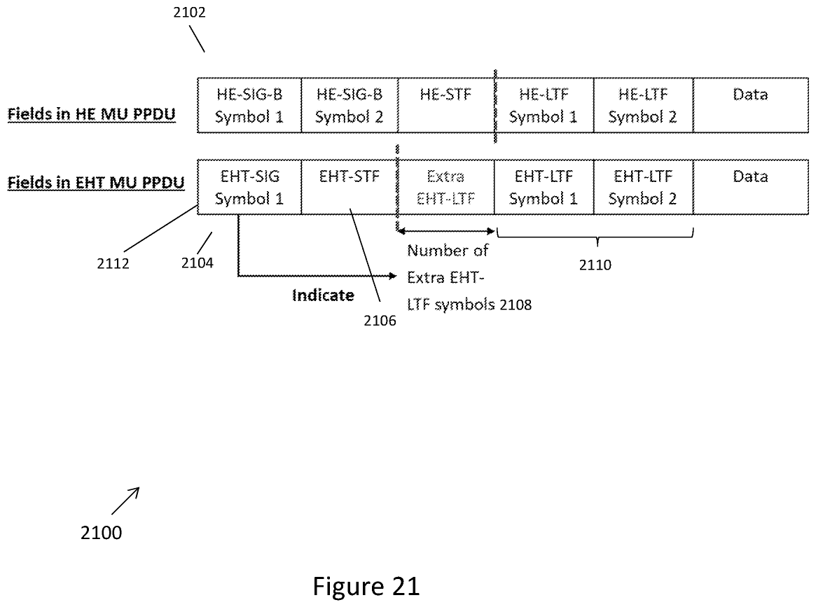

FIG. 21 depicts an example illustration of how Extra EHT-LTF symbols are used for aligning fields of an EHT PPDU (e.g. EHT MU PPDU 2104) with fields of other PPDU(s) (e.g. HE MU PPDU 2102) in accordance with an embodiment 2. The symbol(s) between EHT-STF field and original EHT-LTF field is Extra EHT-LTF symbol(s) (e.g. Extra EHT-LTF symbol 2108 between EHT-STF field 2106 and original EHT-LTF field 2110 of EHT MU PPDU 2104). The number of Extra EHT-LTF symbol(s) shall be indicated in EHT-SIG field (e.g. EHT-SIG field 2112 indicates that number of Extra EHT-LTF symbol 2108 is ‘1’). Further, the Extra EHT-LTF symbol 2108 can only be of ‘1×EHT-LTF+0.8 μs GI’ type. The generation of EHT-LTF field in an EHT PPDU required to be aligned with other PPDUs may be such that the generation procedure is the same as defined in 11be R1 if the number of Extra EHT-LTF symbol is 0.

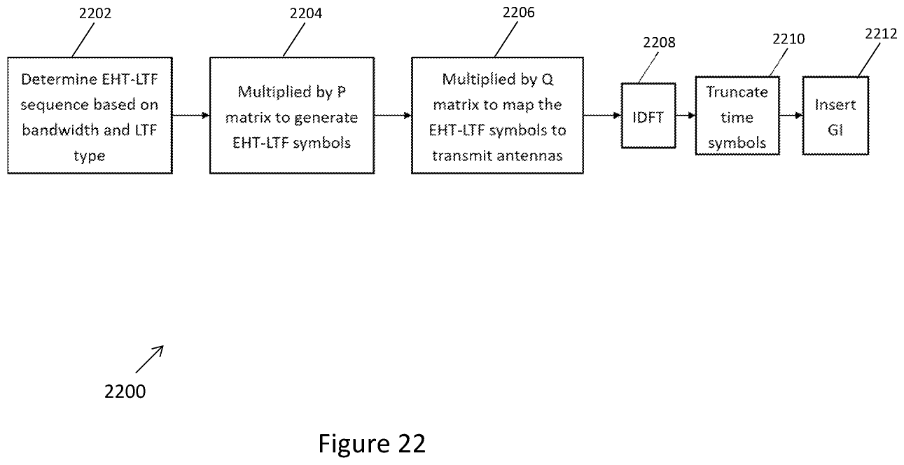

On the other hand, if the number of Extra EHT-LTF symbol(s) is larger than 0, the generation procedure shall depend on whether the original EHT-LTF symbol(s) are of 1×EHT-LTF, 2×EHT-LTF or 4×EHT-LTF type. FIG. 22 depicts an illustration 2200 of how EHT-LTF symbols in an EHT-LTF field are generated according to embodiment 2 if the original EHT-LTF symbols are of 1×EHT-LTF type. In step 2202, EHT-LTF sequence is determined based on bandwidth and LTF type. In step 2204, the sequence is multiplied by a P matrix to generate EHT-LTF symbols. In step 2206, the result of step 2204 is multiplied by a Q matrix to map the EHT-LTF symbols to transmit antennas. In step 2208, IDFT is performed. In step 2210, the time symbols from step 2208 are truncated. In step 2212, GI is inserted. In this case, the Extra EHT-LTF symbols are generated together with the original EHT-LTF symbols in the same manner as defined in 11be R1.

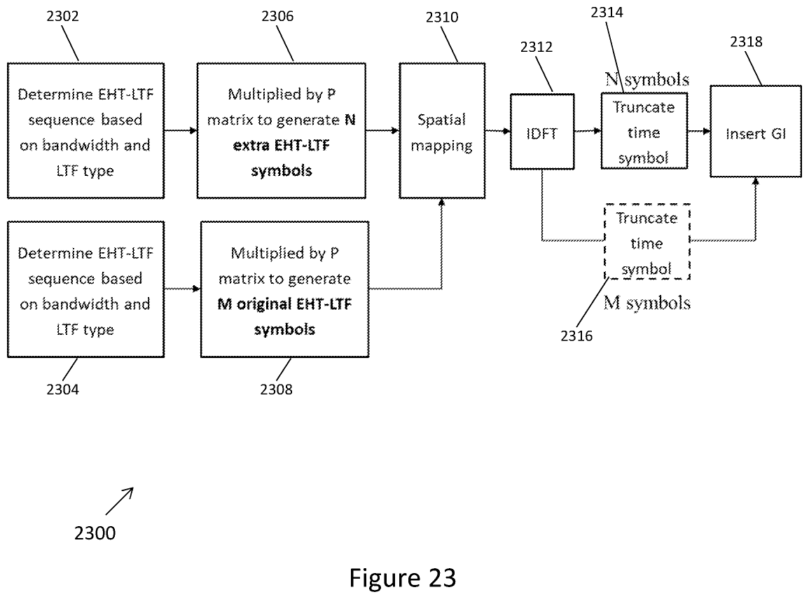

FIG. 23 depicts an illustration 2300 of how EHT-LTF symbols in an EHT-LTF field are generated according to embodiment 2 if the original EHT-LTF symbols are of 2×EHT-LTF or 4×EHT-LTF type. In this illustration 2300, the Extra EHT-LTF symbols are generated separately from the original EHT-LTF symbols. Extra EHT-LTF symbols and original EHT-LTF symbols are generated by corresponding EHT-LTF sequence multiplied by corresponding P matrix. Extra EHT-LTF and original EHT-LTF symbols are converted to time domain symbols separately, and GI is then inserted into the Extra EHT-LTF symbols and original EHT-LTF symbols. In step 2302, EHT-LTF sequence for extra EHT-LTF symbols is determined based on bandwidth and LTF type. In step 2306, the sequence is multiplied by a P matrix to generate N extra EHT-LTF symbols. In step 2304, EHT-LTF sequence for original EHT-LTF symbols is determined based on bandwidth and LTF type. In step 2308, the sequence is multiplied by a P matrix to generate M original EHT-LTF symbols. In step 2310, spatial mapping is performed on the results of steps 2306 and 2308. In step 2312, IDFT is performed. In step 2314, only the N symbols are truncated. In step 2316, the M symbols may be truncated if the M EHT-LTF symbols are of 2×EHT-LTF type, while EHT-LTF symbol of 4×EHT-LTF type does not need to be truncated and this step may thus be skipped. In step 2318, GI is inserted into both the N and M symbols.

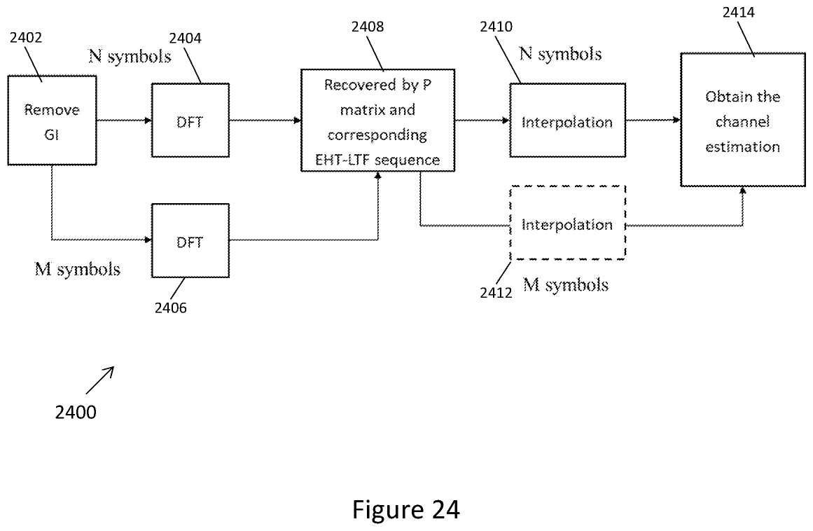

The reception of EHT-LTF symbols in the EHT-LTF field for SU transmission according to embodiment 2 may be such that the EHT-LTF field is demodulated and decoded in the same way as defined in 11be R1 if the EHT-LTF type indicated in EHT-SIG field is ‘1×EHT-LTF’. If the EHT-LTF type indicated in EHT-SIG field is ‘2×EHT-LTF’ or ‘4×EHT-LTF’, there are two possible options. In a first option, the Extra EHT-LTF symbols and EHT-LTF are demodulated and decoded separately. In a second option, the Extra EHT-LTF symbols and EHT-LTF are demodulated separately but decoded together after the extra EHT-LTF symbols are interpolated. FIG. 24 depicts an illustration 2400 of how EHT-LTF symbols in an EHT-LTF field for SU transmission are received in accordance with the second option. In step 2402, GI is removed from both the N symbols (e.g. N symbols of the extra EHT-LTF symbols) and the M symbols (e.g. M symbols of the original EHT-LTF symbols). In steps 2404 and 2406, DFT is performed on the N symbols and the M symbols respectively. In step 2408, the N symbols and M symbols are recovered by P matrix and corresponding EHT-LTF sequence. In step 2410, the N symbols are interpolated. In step 2412, the M symbols may be interpolated. In step 2414, channel estimation information is obtained from the interpolated N symbols and M symbols.

By appropriate assignment of EHT-LTF symbols to users, the reception of EHT-LTF symbols in the EHT-LTF field for MU transmission can be configured to be the same as defined in 11be R1. A requirement is that EHT-LTF symbols assigned to a single user shall be of the same LTF type. In this case, the reception of EHT-LTF symbols in the EHT-LTF field for MU transmission may be such that a receiver STA only demodulates the assigned EHT-LTF symbols and obtains channel information for the assigned Spatial Streams, wherein the reception procedure is the same as defined in 11be R1.

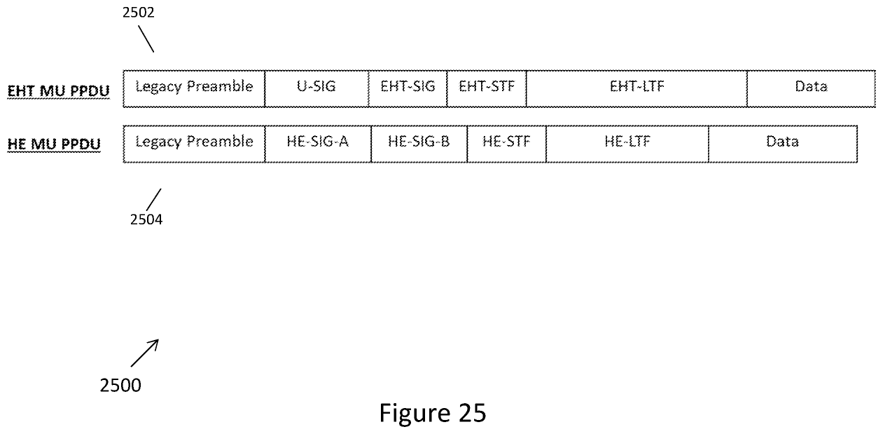

According to an embodiment 3, PPDUs simultaneously sent by one or more than one AP may not be aligned e.g. via unaligned PPDU transmission. FIG. 25 depicts an illustration 2500 according to embodiment 3, in which an EHT MU PPDU 2502 and HE MU PPDU 2504 are simultaneously transmitted even though their fields are not aligned with each other. To achieve this, the AP may use more than one IFFT processor to generate multiple PPDUs in different basebands. In a first option, the AP may have multiple independent 80/160 MHz IFFT/FFT processers, similar to 80+80 MHz PPDU transmission. While the hardware design for 80+80/160+160 MHz PPDU transmission can advantageously be reused for this transmission, the number of PPDUs that can be transmitted/received simultaneously by the AP is limited to 2. In a second option, the AP may have multiple independent IFFT/FFT processors for different basebands (20/40/80/160 MHz). New hardware design is needed for such a transmission, but the number of PPDUs that can be transmitted/received simultaneously by the AP is up to the number of independent IFFT/FFT processors, which advantageously could be larger than 2. An effect that can be seen is that unalignment between multiple PPDUs can bring more flexibility than aligned PPDUs.

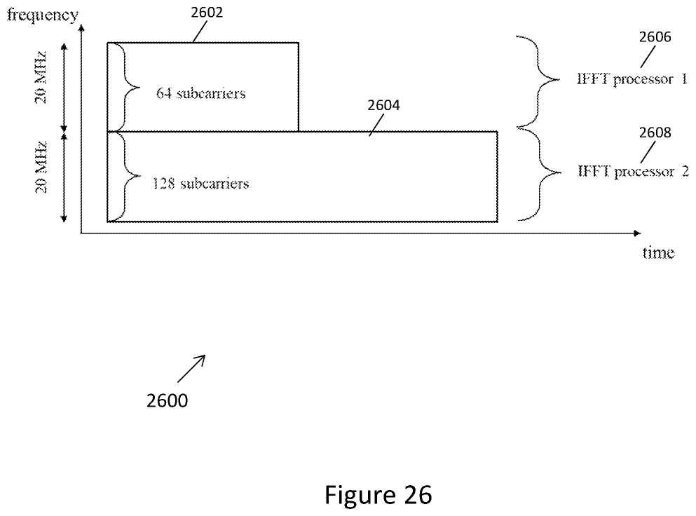

FIG. 26 depicts an illustration 2600 of OFDM transmission with multiple IFFT processors 2606 and 2608 in accordance with embodiment 3. Even though OFDM symbol data parts 2602 and 2604 are not aligned with each other, IFFT processors 2606 and 2608 may be utilized to transmit these unaligned data parts 2602 and 2604. With channel scheduling such as SST (Subchannel Selective Transmission), non-AP STAs are able to receive unaligned PPDUs, although the non-AP STAs only receive the PPDU sent on the baseband that they are allocated to.

Another way to enable reception of unaligned PPDUs is to set up negotiation for such reception of unaligned PPDUs between AP and STAs. The negotiation shall be completed prior to an unaligned PPDUs transmission. Support for multiple IFFT/FFT processors for unaligned PPDUs reception can be indicated in an EHT Capabilities element. For example, in an option 1, support for unaligned PPDUs in 160+160 MHz transmission and support for unaligned PPDUs in 80+80 MHz transmission may be indicated. In an option 2, support for unaligned PPDUs may be indicated along with the number of IFFT/FFT processors that can be utilized for the transmission.

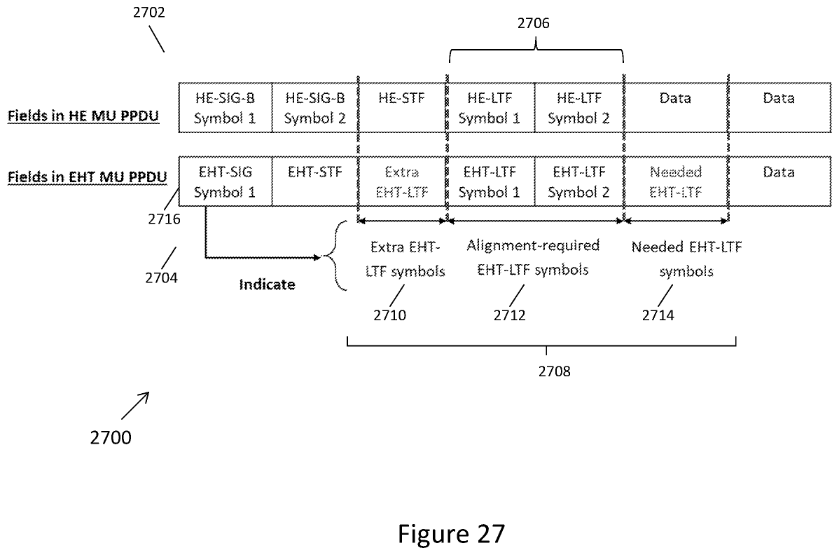

The techniques discussed in embodiments 1 and 2 may also be combined. For example, referring to illustration 2700 of FIG. 27, neither the start or end of an EHT-LTF field (e.g. EHT-LTF field 2708 of EHT MU PPDU 2704) needs to be aligned with the start or end of a HE/EHT-LTF field of other PPDU(s) (e.g. HE-LTF field 2706 of HE MU PPDU 2702). The number of Extra EHT-LTF symbols 2710, Alignment-required EHT-LTF symbols 2712 and Needed EHT-LTF symbols 2714 may be indicated in EHT-SIG field 2716. However, this is only possible when the GI is 0.8 μs. In this case, the generation of EHT-LTF field in an EHT PPDU required to be aligned with other PPDUs may be such that the generation procedure is the same as that discussed in the embodiment 1 if the Extra EHT-LTF symbols and Alignment-required EHT-LTF symbols are of the same EHT-LTF type. Further, if the Alignment-required EHT-LTF symbols and Needed EHT-LTF symbols are of the same EHT-type, the generation procedure is the same as that discussed in the embodiment 2.

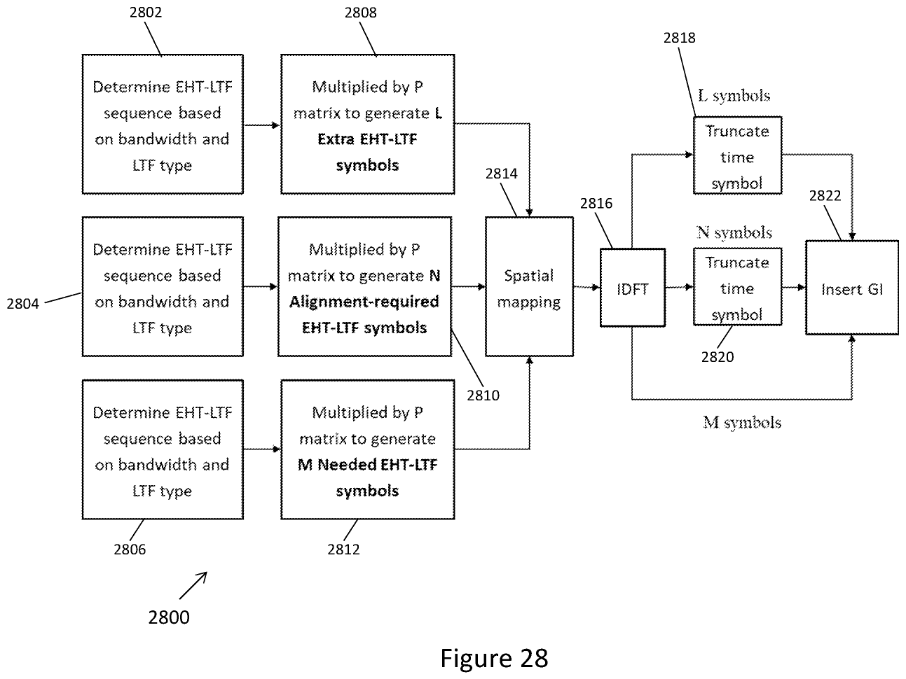

If the EHT-LTF type of three kinds of EHT-LTF symbols are different, the generation procedure may be as shown in illustration 2800 of FIG. 28 which depicts how EHT-LTF symbols of different EHT-LTF types are generated in accordance with a combination of embodiments 1 and 2. In steps 2802, 2804 and 2806, EHT-LTF sequence for Extra EHT-LTF symbols, Alignment-required EHT-LTF symbols and Needed EHT-LTF symbols are determined respectively based on bandwidth and LTF type. In steps 2808, 2810 and 2812, the sequences are each multiplied by a P matrix to generate L Extra EHT-LTF symbols, N Alignment-required EHT-LTF symbols and M Needed EHT-LTF symbols respectively. In step 2814, spatial mapping is performed on the results of steps 2808, 2810 and 2812. In step 2816, IDFT is performed. In step 2818, only the L symbols are truncated. In step 2820, only the M symbols are truncated. In step 2822, GI is inserted into the L, M and N symbols.

In the embodiments discussed herein, a single field in an EHT PPDU that is required to be aligned with other PPDU(s) can include symbols of different parameters. The EHT-LTF field of an EHT PPDU can include EHT-LTF symbols with different LTF types, and the number of EHT-LTF symbols of different LTF types shall be indicated in a field prior to the EHT-LTF field. The EHT-SIG field of an EHT PPDU can include duplicated EHT-SIG symbols or symbols carrying information for 11be R2, and the number of duplicated EHT-SIG symbols or symbols carrying information for R2 shall be indicated in a field prior to the EHT-SIG field. The EHT-STF field of an EHT PPDU can include more than one EHT-STF symbols, and number of EHT-STF symbols shall be indicated in a field prior to EHT-STF field. The reception procedures of EHT-LTF/EHT-SIG/EHT-STF field that include symbols of different parameters, as well as designs to support simultaneous multiple unaligned PPDUs transmission from a single AP are also described in the various embodiments herein.

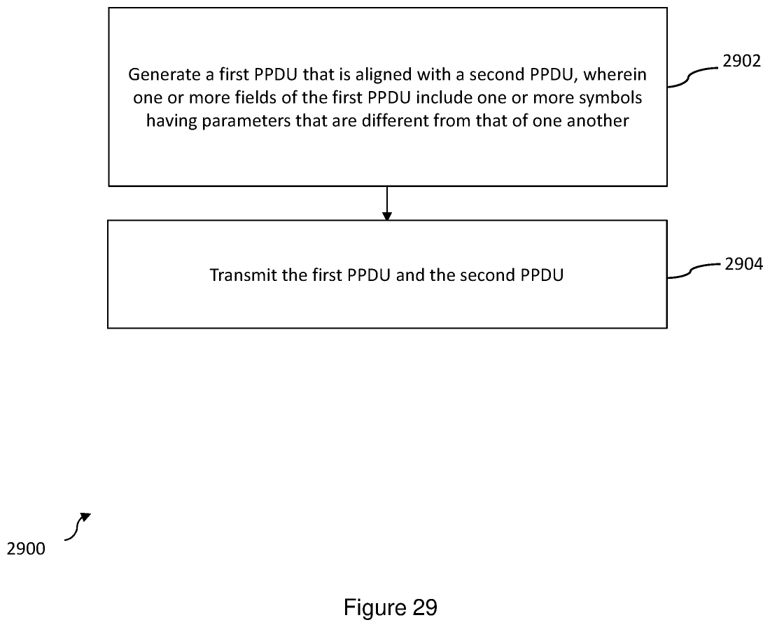

FIG. 29 shows a flow diagram 2900 illustrating a communication method according to various embodiments. At step 2902, a first PPDU that is aligned with a second PPDU is generated, wherein one or more fields of the first PPDU include one or more symbols having parameters that are different from that of one another. At step 2904, the first PPDU and the second PPDU are transmitted.

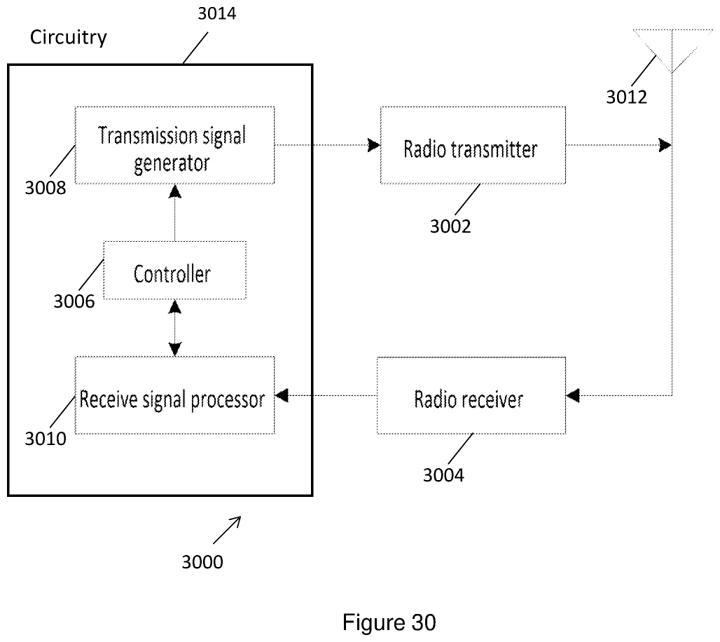

FIG. 30 shows a schematic, partially sectioned view of a communication apparatus 3000 that can be implemented for opportunistic WLAN sensing in accordance with the embodiments 1, 2, 3, and combinations thereof. The communication apparatus 3000 may be implemented as an STA or AP according to various embodiments.

Various functions and operations of the communication apparatus 3000 are arranged into layers in accordance with a hierarchical model. In the model, lower layers report to higher layers and receive instructions therefrom in accordance with IEEE specifications. For the sake of simplicity, details of the hierarchical model are not discussed in the present disclosure.

As shown in FIG. 30, the communication apparatus 3000 may include circuitry 3014, at least one radio transmitter 3002, at least one radio receiver 3004 and multiple antennas 3012 (for the sake of simplicity, only one antenna is depicted in FIG. 30 for illustration purposes). The circuitry may include at least one controller 3006 for use in software and hardware aided execution of tasks it is designed to perform, including control of communications with one or more other devices in a wireless network. The at least one controller 3006 may control at least one transmission signal generator 3008 for generating frames to be sent through the at least one radio transmitter 3002 to one or more other STAs or APs and at least one receive signal processor 3010 for processing frames received through the at least one radio receiver 3004 from the one or more other STAs or APs. The at least one transmission signal generator 3008 and the at least one receive signal processor 3010 may be stand-alone modules of the communication apparatus 3000 that communicate with the at least one controller 3006 for the above-mentioned functions. Alternatively, the at least one transmission signal generator 3008 and the at least one receive signal processor 3010 may be included in the at least one controller 3006. It is appreciable to those skilled in the art that the arrangement of these functional modules is flexible and may vary depending on the practical needs and/or requirements. The data processing, storage and other relevant control apparatus can be provided on an appropriate circuit board and/or in chipsets.

In various embodiments, when in operation, the at least one radio transmitter 3002, at least one radio receiver 3004, and at least one antenna 3012 may be controlled by the at least one controller 3006. Furthermore, while only one radio transmitter 3002 is shown, it will be appreciated that there can be more than one of such transmitters.

In various embodiments, when in operation, the at least one radio receiver 3004, together with the at least one receive signal processor 3010, forms a receiver of the communication apparatus 3000. The receiver of the communication apparatus 3000, when in operation, provides functions required for sensing operations. While only one radio receiver 3004 is shown, it will be appreciated that there can be more than one of such receivers.

The communication apparatus 3000, when in operation, provides functions required for preamble of aligned PPDUs. For example, the communication apparatus 3000 may be a first communication apparatus. The circuitry 3014 may, in operation, generate a first Physical Protocol Data Unit (PPDU) that is aligned with a second PPDU, wherein one or more fields of the first PPDU include one or more symbols having parameters that are different from that of one another. The transmitter 3002 may be a first transmitter and may, in operation, transmit the first PPDU to a second communication apparatus.

The first transmitter may be further configured to transmit the second PPDU to the second communication apparatus or a third communication apparatus, and wherein the first PPDU and the second PPDU are simultaneously transmitted. The first communication apparatus may further comprise a second transmitter, which in operation, transmits the second PPDU to the second communication apparatus or a third communication apparatus.

The first PPDU may be an Extremely High Throughput (EHT) PPDU, wherein the one or more fields comprises an EHT-long training field (EHT-LTF field), and the one or more symbols comprises one or more EHT-LTF symbols, and wherein the one or more EHT-LTF symbols of the EHT-LTF field are of parameters that are different from that of one another. A first part of the one or more EHT-LTF symbols may be of an EHT-LTF type that is same as that of the second PPDU, and a second part of the one or more EHT-LTF symbols may be of a 4×EHT-LTF type and aligned with data symbols of the second PPDU. A first part of the one or more EHT-LTF symbols may be of a 1×EHT-LTF type and aligned with pre-EHT modulated symbols or EHT-short training field (EHT-STF) symbols of the second PPDU, and a second part of the one or more EHT-LTF symbols may be of an EHT-LTF type that is same as that of the second PPDU. Quantity of EHT-LTF symbols in a first part and in a second part of the one or more EHT-LTF symbols may be indicated in a field prior to the EHT-LTF field.

The first PPDU may be an EHT PPDU, wherein the one or more fields comprises an EHT-signal (EHT-SIG) field, and the one or more symbols comprises one or more duplicated EHT-SIG symbols or other symbols carrying information that is different from the EHT-SIG symbols. Quantity of the one or more other symbols may be indicated in a field prior to the EHT-SIG field.

The communication apparatus 3000 may be a second communication apparatus. The receiver 3004 may, in operation, receive a first PPDU from a first communication apparatus, wherein the first PPDU is aligned with a second PPDU, wherein one or more fields of the first PPDU includes one or more symbols having parameters that are different from that of one another. The circuitry 3014 may, in operation, demodulate and decode the symbols based on the parameters.

The one or more fields may comprise an EHT-LTF field and the one or more symbols may comprise one or more EHT-LTF symbols with different LTF types, and wherein the circuitry 3014 may be further configured to demodulate and decode the one or more EHT-LTF symbols with different LTF types separately. The one or more fields may comprise an EHT-SIG field and the one or more symbols may comprise one or more EHT-SIG symbols, and one or more duplicated EHT-SIG symbols or other symbols carrying information that is different from the EHT-SIG symbols, and wherein the circuitry 3014 may be further configured to combine, demodulate and decode the one or more EHT-SIG symbols with the one or more duplicated EHT-SIG symbols together, or demodulate and decode the one or more EHT-SIG symbols and the other symbols separately.

The communication apparatus 3000 may be an access point (AP). The receiver 3004 may, in operation, receive a plurality of unaligned PPDUs. The circuitry 3014 may, in operation, demodulate and decode the plurality of unaligned PPDUs utilizing a plurality of fast fourier transform (FFT) and inverse FFT (IFFT) processors.

The circuitry 3014 may be further configured to generate the plurality of unaligned PPDUs utilizing the plurality of IFFT and FFT processors, and wherein the transmitter 3002 may, in operation, transmit the plurality of unaligned PPDUs to a station (STA). The AP may comprise two IFFT and FFT processors for 80+80/160+160 Mhz PPDU transmissions, and wherein the transmitter 3002 may be further configured to perform 80+80/160+160 Mhz PPDU transmissions utilizing the two IFFT and FFT processors. The AP may be further configured to utilize each of the plurality of IFFT and FFT processors for different basebands. The circuitry 3014 may be further configured to indicate support for unaligned PPDU transmission or reception prior to transmission or reception of the plurality of unaligned PPDUs.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra-LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication device.

Some non-limiting examples of such communication device include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication device is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication device may comprise an apparatus such as a controller or a sensor which is coupled to a communication apparatus performing a function of communication described in the present disclosure. For example, the communication device may comprise a controller or a sensor that generates control signals or data signals which are used by a communication apparatus performing a communication function of the communication device.

The communication device also may include an infrastructure facility, such as a base station, an access point, and any other apparatus, device or system that communicates with or controls apparatuses such as those in the above non-limiting examples.

A non-limiting example of a station may be one included in a first plurality of stations affiliated with a multi-link station logical entity (i.e. such as an MLD), wherein as a part of the first plurality of stations affiliated with the multi-link station logical entity, stations of the first plurality of stations share a common medium access control (MAC) data service interface to an upper layer, wherein the common MAC data service interface is associated with a common MAC address or a Traffic Identifier (TID).

Thus, it can be seen that the present embodiments provide communication devices and methods for preamble of aligned PPDUs.

While exemplary embodiments have been presented in the foregoing detailed description of the present embodiments, it should be appreciated that a vast number of variations exist. It should further be appreciated that the exemplary embodiments are examples, and are not intended to limit the scope, applicability, operation, or configuration of this disclosure in any way. Rather, the foregoing detailed description will provide those skilled in the art with a convenient road map for implementing exemplary embodiments, it being understood that various changes may be made in the function and arrangement of steps and method of operation described in the exemplary embodiments and modules and structures of devices described in the exemplary embodiments without departing from the scope of the subject matter as set forth in the appended claims.

1. A first communication apparatus comprising:
circuitry, which in operation, generates a first Physical Protocol Data Unit (PPDU) that is aligned with a second PPDU, wherein one or more fields of the first PPDU include one or more symbols having parameters that are different from that of one another; and
a first transmitter, which in operation, transmits the first PPDU to a second communication apparatus.

2. The first communication apparatus according to claim 1, wherein the first transmitter is further configured to transmit the second PPDU to the second communication apparatus or a third communication apparatus, and wherein the first PPDU and the second PPDU are simultaneously transmitted.

3. The first communication apparatus according to claim 1, further comprising a second transmitter, which in operation, transmits the second PPDU to the second communication apparatus or a third communication apparatus.

4. The first communication apparatus according to claim 1, wherein the first PPDU is an Extremely High Throughput (EHT) PPDU, the one or more fields comprises an EHT-long training field (EHT-LTF field), and the one or more symbols comprises one or more EHT-LTF symbols, and wherein the one or more EHT-LTF symbols of the EHT-LTF field are of parameters that are different from that of one another.

5. The first communication apparatus according to claim 4, wherein a first part of the one or more EHT-LTF symbols are of an EHT-LTF type that is same as that of the second PPDU, and a second part of the one or more EHT-LTF symbols are of a 4×EHT-LTF type and aligned with data symbols of the second PPDU.

6. The first communication apparatus according to claim 4, wherein a first part of the one or more EHT-LTF symbols are of a 1×EHT-LTF type and aligned with pre-EHT modulated symbols or EHT-short training field (EHT-STF) symbols of the second PPDU, and a second part of the one or more EHT-LTF symbols are of an EHT-LTF type that is same as that of the second PPDU.

7. The first communication apparatus according to claim 4, wherein quantity of EHT-LTF symbols in a first part and in a second part of the one or more EHT-LTF symbols are indicated in a field prior to the EHT-LTF field.

8. The first communication apparatus according to claim 1, wherein the first PPDU is an EHT PPDU, the one or more fields comprises an EHT-signal (EHT-SIG) field, and the one or more symbols comprises one or more duplicated EHT-SIG symbols or other symbols carrying information that is different from the EHT-SIG symbols.

9. The first communication apparatus according to claim 8, wherein quantity of the one or more other symbols is indicated in a field prior to the EHT-SIG field.

10. A second communication apparatus comprising:
a receiver, which in operation, receives a first PPDU from a first communication apparatus, wherein the first PPDU is aligned with a second PPDU, wherein one or more fields of the first PPDU includes one or more symbols having parameters that are different from that of one another; and
circuitry, which in operation, demodulates and decodes the symbols based on the parameters.

11. The second communication apparatus according to claim 10, wherein the one or more fields comprises an EHT-LTF field and the one or more symbols comprises one or more EHT-LTF symbols with different LTF types, and wherein the circuitry is further configured to demodulate and decode the one or more EHT-LTF symbols with different LTF types separately.

12. The second communication apparatus according to claim 10, wherein the one or more fields comprises an EHT-SIG field and the one or more symbols comprises one or more EHT-SIG symbols, and one or more duplicated EHT-SIG symbols or other symbols carrying information that is different from the EHT-SIG symbols, and wherein the circuitry is further configured to combine, demodulate and decode the one or more EHT-SIG symbols with the one or more duplicated EHT-SIG symbols together, or demodulate and decode the one or more EHT-SIG symbols and the other symbols separately.

13. An access point (AP) comprising:
a receiver, which in operation, receives a plurality of unaligned PPDUs; and
circuitry, which in operation, demodulates and decodes the plurality of unaligned PPDUs utilizing a plurality of fast fourier transform (FFT) and inverse FFT (IFFT) processors.

14. The AP according to claim 13, wherein the circuitry is further configured to generate the plurality of unaligned PPDUs utilizing the plurality of IFFT and FFT processors, and wherein the AP further comprises a transmitter, which in operation, transmits the plurality of unaligned PPDUs to a station (STA).

15. The AP according to claim 14, wherein the AP comprises two IFFT and FFT processors for 80+80/160+160 Mhz PPDU transmissions, and wherein the transmitter is further configured to perform 80+80/160+160 Mhz PPDU transmissions utilizing the two IFFT and FFT processors.

16. The AP according to claim 14, wherein the AP is further configured to utilize each of the plurality of IFFT and FFT processors for different basebands.

17. The AP according to claim 14, wherein the circuitry is further configured to indicate support for unaligned PPDU transmission or reception prior to transmission or reception of the plurality of unaligned PPDUs.

18. A communication method comprising:
generating a first PPDU that is aligned with a second PPDU, wherein one or more fields of the first PPDU include one or more symbols having parameters that are different from that of one another; and
transmitting the first PPDU and the second PPDU.
